(19) United States
(12) Patent Application Publication
(10) Pub. No.: US 2023/0334597 A1
(43) Pub. Date: Oct. 19, 2023

(54) TRANSACTION ASSISTANCE SYSTEM, COMPUTER PROGRAM FOR TRANSACTION ASSISTANCE SYSTEM, AND METHOD OF CONTROL FOR TRANSACTION ASSISTANCE SYSTEM

(71) Applicant: MISUMI GROUP INC., Tokyo (JP)

(72) Inventors: Kenji NAKAGAWA, Tokyo (JP); Tomohiro ASANO, Tokyo (JP); Misa SONG, Tokyo (JP); Wataru KADOBAYASHI, Tokyo (JP); Shimpei YAMAGUCHI, Tokyo (JP)

(73) Assignee: MISUMI GROUP INC., Tokyo (JP)

(21) Appl. No.: 18/044,543

(22) PCT Filed: Feb. 10, 2022
(86) PCT No.: PCT/JP2022/005279

§ 371 Date: Mar. 8, 2023

(30) Foreign Application Priority Data
Mar. 12, 2021 (JP) 2021-039925

(51) Int. Cl. G06Q 50/04; G06Q 10/0631

(52) U.S. Cl. CPC G06Q 50/04; G06Q 10/06315

(57) ABSTRACT

A transaction assistance system determining a provision requirement for providing a service, to assist closing a transaction has: a service setting unit setting, in association with service information of each service used in relation to selection of the service, a service candidate group including services providable to the user; an information item setting unit setting, for each service in the service candidate group, an information item necessary for the supplier for determining the provision requirement; a service selection unit selecting the service provided in response to a user demand from the service candidate group using the service information and selection information acquired based on a user instruction; a request acquiring unit acquiring, based on a user instruction, request information for specifying a request by the user for the information item; and a determining unit determining the provision requirement based on the request information.

### CROSS-REFERENCE TO RELATED PATENT APPLICATIONS

This application is a U.S. National Phase Application under 35 U.S.C. § 371 of International Patent Application No. PCT/JP2022/005279 filed on Feb. 10, 2022 and claims the benefit of priority to Japanese Patent Application No. 2021-039925 filed on Mar. 12, 2021, the contents of all of which are incorporated herein by reference in their entireties. The International Application was published in Japanese on Sep. 15, 2022 as International Publication No. WO 2022/190757 under PCT Article 21(2).

### FIELD OF THE INVENTION

The present invention relates to a transaction assistance system for assisting with closing of a transaction between a supplier and a user by determining a provision requirement for providing a service, a computer program for the transaction assistance system, and a method of control for the transaction assistance system.

### BACKGROUND OF THE INVENTION

JP2016-062403A discloses an automatic estimation system. In the automatic estimation system, a shape recognition processing part recognizes a shape of an item described in shape data input by a user. In addition, a display information processing part acquires selectable manufacturing conditions based on a type of the item input by the user and the recognized shape of the item.

Furthermore, a display processing part displays an outline of the recognized item in an item shape display part and displays the manufacturing conditions in a manufacturing condition selection part on a displayed screen. The user selects any manufacturing condition among the manufacturing conditions displayed in the manufacturing condition selection part. In addition, the user selects an estimation start part being displayed in a display part to cause the automatic estimation system to start estimation processing.

### CITATION LIST

### Patent Literature

[Patent Literature 1] JP2016-062403A

### TECHNICAL PROBLEM

A user who desires to be provided with a service follows procedures including estimation to close a transaction with a supplier who provides the service. In this case, the service which can be provided by the supplier may not match the service which the user desires to be provided with. For example, a user desiring a manufacturing service of a product first presents a supplier with information such as product specifications when looking for a supplier. Subsequently, the supplier replies to the user about whether or not the supplier is capable of manufacturing a product in accordance with the presented product specifications. At this point, the supplier may ask the user to provide further information in order to determine whether or not the product can be manufactured. Subsequently, when the supplier replies that the product cannot be manufactured as a result of the determination, the user must look for a supplier once again. The user is to repetitively present information to suppliers until a supplier capable of providing the desired service is found. Therefore, the user must repeat the same work over and over again.

### SUMMARY OF THE INVENTION

### Solution to Problem

A transaction assistance system according to an aspect of the present invention is a transaction assistance system determining a provision requirement for providing a service between a supplier providing the service and a user demanding provision of the service to assist with closing of a transaction between the supplier and the user, the transaction assistance system comprising: a service setting unit configured to set, in association with service information of each service used in relation to selection of the service, a service candidate group including a plurality of services which are providable to the user; an information item setting unit configured to set, for each service included in the service candidate group, an information item necessary for the supplier in order to determine the provision requirement; a service selection unit configured to select the service provided in response to a demand by the user from the service candidate group using the service information and selection information acquired based on an instruction by the user; a request acquiring unit configured to acquire, based on an instruction by the user, request information for specifying a request by the user with respect to the information item set in association with the selected service; and an determining unit configured to determine the provision requirement based on the acquired request information.

A computer program for a transaction assistance system according to an aspect of the present invention is a computer program for a transaction assistance system which includes a computer and which is configured to determine a provision requirement for providing a service between a supplier providing the service and a user demanding provision of the service to assist with closing of a transaction between the supplier and the user, the computer program causing the computer to function as: a service setting unit configured to set, in association with service information of each service used in relation to selection of the service, a service candidate group including a plurality of services which are providable to the user; an information item setting unit configured to set, for each service included in the service candidate group, an information item necessary for the supplier in order to determine the provision requirement; a service selection unit configured to select the service provided in response to a demand by the user from the service candidate group using the service information and selection information acquired based on an instruction by the user; a request acquiring unit configured to acquire, based on an instruction by the user, request information for specifying a request by the user with respect to the information item set in association with the selected service; and an determining unit configured to determine the provision requirement based on the acquired request information.

A method of control for a transaction assistance system according to an aspect of the present invention is a method of control for a transaction assistance system which includes a computer and which is configured to determine a provision requirement for providing a service between a supplier providing the service and a user demanding provision of the service to assist with closing of a transaction between the supplier and the user, the method of control causing the computer to: set, in association with service information of each service used in relation to selection of the service, a service candidate group including a plurality of services which are providable to the user; set, for each service included in the service candidate group, an information item necessary for the supplier in order to determine the provision requirement; select the service provided in response to a demand by the user from the service candidate group using the service information and selection information acquired based on an instruction by the user; acquire, based on an instruction by the user, request information for specifying a request by the user with respect to the information item set in association with the selected service; and determine the provision requirement based on the acquired request information.

### BRIEF DESCRIPTION OF THE DRAWINGS

FIG. 1 is a schematic view showing an overall configuration of a transaction assistance system.

FIG. 2 is a schematic block diagram of the transaction assistance system.

FIG. 3 is a schematic block diagram of a server control part.

FIG. 4 is a schematic view showing a service card list screen.

FIG. 5 is a schematic view showing a service content screen.

FIG. 6 is a schematic view showing a supplier screen.

FIG. 7 is a schematic view showing a case example screen.

FIG. 8 is a schematic view showing a project list screen.

FIG. 9 is a schematic view showing a project detail screen.

FIG. 10 is a schematic view showing an article image screen.

FIG. 11 is a schematic view showing a case list screen.

FIG. 12 is a schematic view showing a case detail screen.

FIG. 13 is a schematic view showing product specifications.

FIG. 14 is a flow chart of a transaction assistance flow.

### DETAILED DESCRIPTION OF THE INVENTION

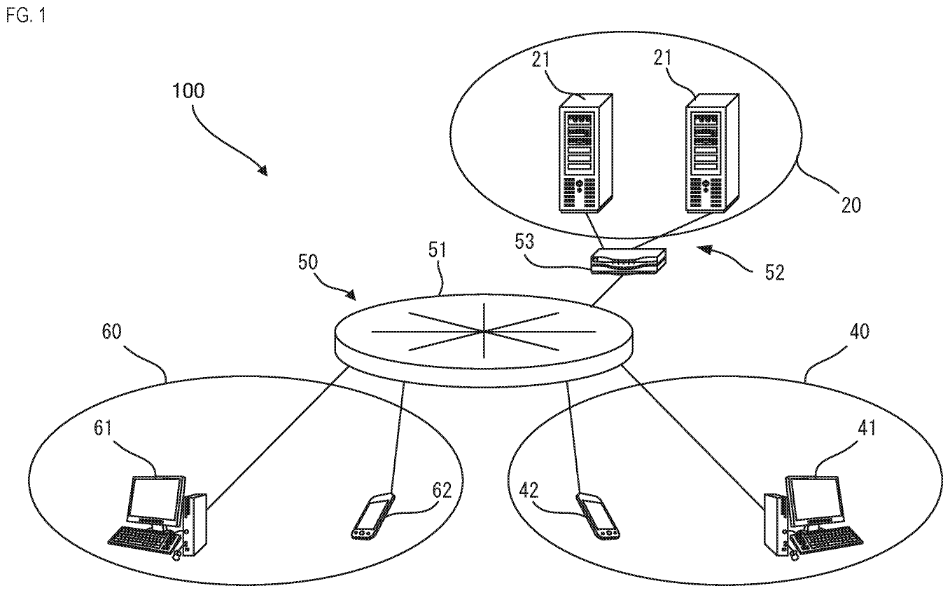

Hereinafter, an embodiment of the present invention will be described with reference to the accompanying drawings. FIG. 1 shows an example of a transaction assistance system 100 for assisting with closing of a transaction between a supplier and a user. The transaction assistance system 100 assists the closing of a transaction by determining a provision requirement (for example, product specifications which the supplier is capable of accepting) for providing a service between a supplier who provides the service and a user who desires to be provided with the service. A transaction includes a service provision agreement such as an agreement to provide any of services including manufacturing, processing, data creation, and measurement. In addition, a transaction includes an agreement to provide other work related to service provision such as an agreement to provide work including estimation, creation of specifications, and introduction.

When closing a transaction without using the transaction assistance system 100, the user searches for a supplier capable of providing a service by a method such as an introduction from an acquaintance or an Internet search. In such cases, since a provision capability of each supplier is unknown, the user ends up spending a lot of time to narrow a plurality of searched suppliers down to a supplier capable of providing the service desired by the user. For example, there are only a few suppliers capable of mass-producing a small amount of (for example, 100 or more and less than 10,000) products. Specifically, a supplier providing a service of manufacturing a prototype is unlikely to have facilities for mass-producing a product or unlikely to be capable of maintaining quality of mass-produced products. In addition, a supplier providing a service of mass-producing a product is likely to be only capable of manufacturing a small amount of the products at a high unit price or incapable of manufacturing the products in a short period of time. Furthermore, some suppliers may not possess facilities which enable products in accordance with product specifications desired by the user to be manufactured.

Therefore, conditions desired by a user and a service provision capability of suppliers are often at odds with each other and it is difficult for the user to find a supplier capable of providing the service required by the user. Furthermore, when manufacturing a small amount of products made up of a wide variety of parts or when some of the parts require special processing, a supplier must be sourced for each part. As a result, the user must devote much time and effort in order to find a supplier. In this regard, according to the transaction assistance system 100, a service desired by the user and a service which a supplier is capable of providing can be matched through an information item to be described later. Therefore, since a service which a supplier is capable of providing and a service desired by the user can be made to match each other, adjustment work for closing a transaction can be simplified and, at the same time, a mismatch can be prevented from being revealed after the closing of the transaction.

Hereinafter, the transaction assistance system 100 will be described with reference to FIG. 1. The transaction assistance system 100 is configured as a network system or a client-server system. However, the transaction assistance system 100 may be constituted of a single server apparatus. In addition, the transaction assistance system 100 includes a transaction assistance server 20, and a user terminal 40 and a supplier terminal 60 as clients which are communicably connected to the transaction assistance server 20 via a network 50. The user terminal 40 and the supplier terminal 60 are computer apparatuses which can be connected to a network. For example, the user terminal 40 includes various devices which can be connected to a network such as a stationary computer apparatus 41 or a mobile terminal 42 such as a smartphone. In a similar manner, the supplier terminal 60 includes devices such as a computer apparatus 61 or a mobile terminal 62.

The transaction assistance server 20 is configured as a single logical server apparatus by combining a plurality of server units 21 as a plurality of computers. However, the transaction assistance server 20 may be constituted of a single server unit 21. Alternatively, the transaction assistance server 20 may be logically constructed using cloud computing. The transaction assistance server 20 may authenticate a user by receiving user identification information which identifies the user from the user terminal 40. In addition, the transaction assistance server 20 may authenticate a supplier by receiving supplier identification information which identifies the supplier from the supplier terminal 60.

Furthermore, the transaction assistance server 20 may save various kinds of data uploaded by the authenticated user or supplier. In this case, the transaction assistance server 20 may provide the user terminal 40 and the supplier terminal 60 with saved data. In addition, in association with a transaction of which a provision requirement has been determined, the transaction assistance server 20 may perform processing such as arranging for a service ordered by the user, delivery of a product, and charging for provision of the service. Furthermore, the transaction assistance server 20 may collect a fee with respect to the provision of the service by the supplier from the user. Moreover, the transaction assistance server 20 may collect a fee for using the transaction assistance system 100 from the user or the supplier.

The network 50 is configured to be capable of respectively connecting the user terminal 40 and the supplier terminal 60 to the transaction assistance server 20. As an example, the network 50 is configured to realize network communication using the TCP/IP protocol. Specifically, a LAN 52 connects the transaction assistance server 20 and the Internet 51 to each other. In addition, the Internet 51 as a WAN and the LAN 52 are connected via a router 53. The user terminal 40 and the supplier terminal 60 are also configured to be connected to the Internet 51. Furthermore, the network 50 may be any of a dedicated line, a telephone line, an intranet, a mobile communication network, other communication lines, or a combination thereof and may be either a wired or a wireless network. The server units 21 of the transaction assistance server 20 may be connected to each other by the Internet 51 in place of or in addition to the LAN 52.

By implementing various kinds of computer software, the user terminal 40 and the supplier terminal 60 enables the user and the supplier to reap the benefits of assistance by the transaction assistance server 20. In addition, the user terminal 40 and the supplier terminal 60 are either equipped with a display part which is a display apparatus such as a display or a touch panel or connected to a display part in a wired or wireless manner Furthermore, the user terminal 40 and the supplier terminal 60 may be any of various kinds of computer apparatuses such as a book-type personal computer and a portable tablet terminal apparatus.

The transaction assistance server 20 provides guidance via the user terminal 40 and the supplier terminal 60 on various procedures necessary for closing a transaction between the supplier and the user. As an example, the transaction assistance server 20 is configured as a web server which causes various web pages to be displayed on the user terminal 40 and the supplier terminal 60 in accordance with accesses made from the user terminal 40 and the supplier terminal 60. Hereinafter, a case where the user terminal 40 and the supplier terminal 60 use a web browser to display web pages will be described as an example.

[Outline of Guided Procedures]

As an example, the transaction assistance server 20 provides guidance on procedures such as those described below. First, the user accesses a web page provided by the transaction assistance server 20 from the user terminal 40. Subsequently, the transaction assistance server 20 authenticates the user terminal 40 using user information such as user identification information and a password which has been acquired in advance and which is stored for each user. In addition, the transaction assistance server 20 presents the user with a service candidate group including a plurality of services which the user can be provided with. Each service which makes up the service candidate group is associated with service information of each service which is used in relation to selecting a service. As an example, the transaction assistance server 20 causes a virtual card (hereinafter, also referred to as a “service card”) which is associated with service information via card identification information for identifying each card to be lined up and displayed in the display part of the user terminal 40 as a service which makes up the service candidate group.

The user picks out a service card corresponding to a desired service from the displayed service candidate group. For example, when the user designates a service card, the transaction assistance server 20 displays at least a part of service information. As an example, the service information includes content information indicating contents of a service associated with the service card, supplier information which enables the user to comprehend a supplier who provides each service, and case example information indicating a case example of the service provided by the supplier. In addition, the user selects a service card associated with a desired service using the service information. In the present specification, the designation by the user includes a designation by voice input or the like or a designation automatically performed by the system accompanying some kind of a user operation in addition to a designation by an operation via an input apparatus such as a touch operation or a click operation with respect to an icon or the like.

In response to the selection operation by the user, the transaction assistance server 20 selects a service card and associates the service card with user information. As an example, the transaction assistance server 20 stores card identification information in association with user identification information. In addition, when the user performs an operation for using the selected service card, the transaction assistance server 20 includes the selected service card in at least one of projects to be a unit for managing a plurality of processing steps (or tasks) for determining a provision requirement. In this case, the transaction assistance server 20 may include the service card in a newly created project or include the service card in a project which has already been created.

When the user selects a project, the transaction assistance server 20 causes an information item required by the supplier to determine the provision requirement to be displayed. The information item is set in association with each service card included in the selected project or, in other words, in association with each selected service. The user inputs request information (for example, product specifications) for specifying a request by the user with respect to the information item. In addition, the user performs an operation for asking the supplier for an estimation. Furthermore, the transaction assistance server 20 saves the request information and notifies the supplier that an estimation has been requested.

The supplier (including a person in charge of the supplier) confirms the notification from the transaction assistance server 20 and accesses the web page provided by the transaction assistance server 20 from the supplier terminal 60. Subsequently, the transaction assistance server 20 authenticates the supplier terminal 60 using supplier information such as supplier identification information and a password which has been acquired in advance and which is stored for each supplier. In addition, the transaction assistance server 20 causes a project list including a project for which an estimation has been requested in the display part of the supplier terminal 60. When the supplier selects the project for which an estimation has been requested, the transaction assistance server 20 causes request information input by the user to be displayed. Furthermore, the supplier confirms the request information, inputs an estimation, and sends a reply to the user. In addition, the transaction assistance server 20 stores a content of the estimation and notifies the user that an estimation reply has been sent. Furthermore, when necessary, the user or the supplier can contact each other using a communication function to be described later.

[Transaction Assistance Server]

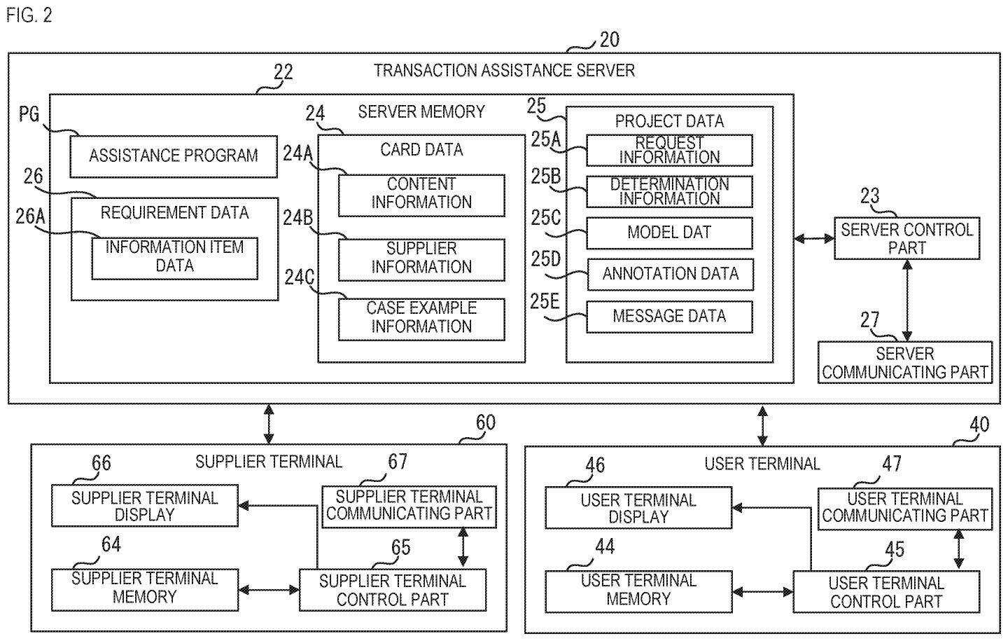

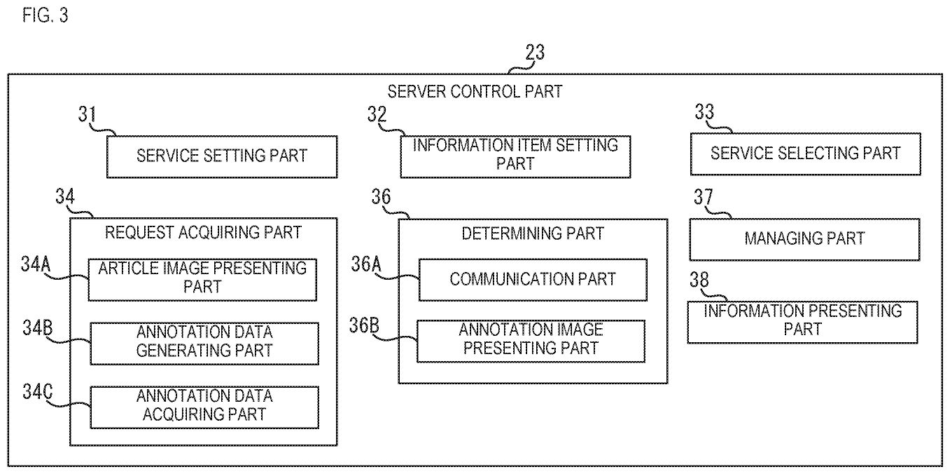

A control system of the transaction assistance server 20 will be described with reference to FIGS. 2 and 3. The transaction assistance server 20 includes a server control part 23 which controls the transaction assistance server 20 and a server memory 22 being an example of a storage means which stores an assistance program PG. The server control part 23 is configured as a computer combining a processor which executes various calculation processing steps and operation control in accordance with a predetermined program with other peripheral apparatuses. In addition, the transaction assistance server 20 includes a server communicating part 27 as an example of a communication apparatus which transmits and receives data to and from the user terminal 40 and the supplier terminal 60. Alternatively, a cloud-type database may function as the storage means.

As an example, the processor of the server control part 23 is a CPU (Central Processing Unit) or an MPU (Micro-Processing Unit) which controls the entire transaction assistance server 20 and comprehensively controls various processing steps based on a program stored in the server memory 22. In addition, the server memory 22 is a computer-readable non-transitory storage medium. The storage medium includes storage apparatuses such as a RAM (Random Access Memory) which is a system work memory for the processor to operate and a ROM (Read Only Memory), an HDD (Hard Disc Drive), an SSD (Solid State Drive), and the like which store a program and system software. Hereinafter, a case where the processor executes various processing operations such as calculations, control, and discrimination in accordance with the assistance program PG which is stored in the ROM or the HDD and which is an example of a computer program. The assistance program PG causes the server control part 23 which is an example of a computer to function as each functional part.

An interface including a keyboard or various switches for inputting predetermined commands and data is connected to the server control part 23 in a wired or wireless manner In addition, a monitor for displaying an input state, a setting state, or a measurement result of an apparatus and various kinds of information is connected to the server control part 23 in a wired or wireless manner Furthermore, the server control part 23 can also perform control in accordance with a program stored in a portable recording medium such as a CD (Compact Disc), a DVD (Digital Versatile Disc), a CF (Compact Flash) card, or a USB (Universal Serial Bus) memory or in an external storage medium such as a server on the Internet.

The server control part 23 will be further described with reference to FIG. 3. The server control part 23 includes a service setting part 31 which is an example of a service setting means, an information item setting part 32 which is an example of an information item setting means, a service selecting part 33 which is an example of a service selection means, a request acquiring part 34 which is an example of a request acquiring means, and a determining part 36 which is an example of a determining means. In addition, the request acquiring part 34 includes an article image presenting part 34A which is an example of an article image presentation means, an annotation data generating part 34B which is an example of an annotation data generation means, and an annotation data acquiring part 34C which is an example of an annotation data acquiring means. Furthermore, the determining part 36 includes a communication part 36A which is an example of a communication means and an annotation image presenting part 36B which is an example of an annotation image presentation means. Moreover, the server control part 23 includes a managing part 37 which is an example of a management means and an information presenting part 38 which is an example of an information presentation means for presenting the user or the supplier with various kinds of information.

The service setting part 31, the information item setting part 32, the service selecting part 33, the request acquiring part 34, the article image presenting part 34A, the annotation data generating part 34B, the annotation data acquiring part 34C, the determining part 36, the communication part 36A, the annotation image presenting part 36B, the managing part 37, and the information presenting part 38 each function as a functional part as the server control part 23 executes the assistance program PG. Each functional part is a logical apparatus which is realized by cooperation between computer hardware and software. At least a part of the functional parts can be provided in the user terminal 40 or the supplier terminal 60. In addition, at least a part of the functional parts may be provided in external computer apparatuses. In this case, programs of the respective apparatuses cooperate to function as the assistance program PG.

[Service Setting Means]

The service setting part 31 sets, in association with service information of each service which is used in relation to selecting a service, a service candidate group including a plurality of services which can be provided to the user. For example, the service setting part 31 sets, in association with service information, a service candidate group made up of services input by the supplier or a manager of the transaction assistance server 20. The user can use the service information by referring to the service information and select a service. Furthermore, an AI created by machine learning can refer to service information based on information (such as a keyword used for a search and a past transaction history) acquired from the user and automatically select a service.

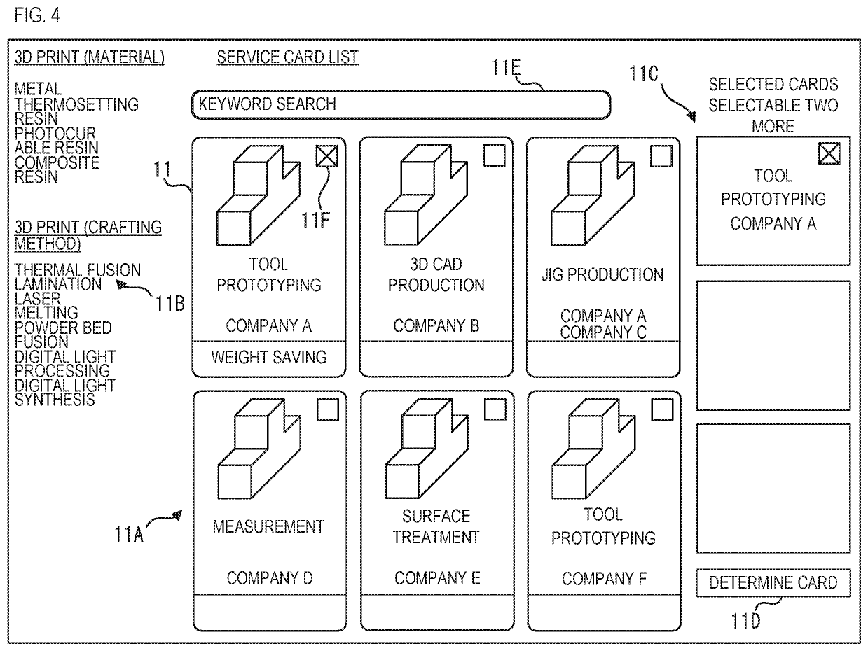

In addition, the service setting part 31 sets information which enables the user to comprehend each service as service information. As an example, the supplier sends a service to be included in the service candidate group and service information corresponding to the service to the transaction assistance server 20 via the supplier terminal 60. In addition, the service setting part 31 sets the service as a part of the service candidate group in association with the received service information. Furthermore, the service setting part 31 sets a service card 11 (FIG. 4) as a medium indicating information which enables the user to comprehend each service. As another example, information which enables the user to comprehend each service may be a service name, an image, or a character string indicating an outline of each service.

The service selecting part 33 presents the user with at least a part of the services included in the service candidate group as options in selecting a service. As an example, as shown in FIG. 4, the service selecting part 33 presents the user with the service card 11 indicating each service which makes up the service candidate group. FIG. 4 is a service card list screen which is an example of presentation of options by the service selecting part 33. However, the service selecting part 33 may present a plurality of images, service names, or the like which correspond to services side by side as information which enables the user to comprehend each service. As an example, the service candidate group includes article-related services which require work by the supplier related to the article such as manufacturing, processing, data creation, or measurement. In addition, the article-related services include an article manufacturing service which requires the article being manufactured by the supplier as work. Furthermore, the service candidate group may include other services such as creating specifications or making introductions.

The service card list screen is displayed in a display part of the user terminal 40. In addition, the service card list screen is provided with a card field 11A in which a plurality of service cards 11 are displayed side by side. While six service cards 11 are arranged in a matrix formed by three lateral cards by two longitudinal cards in the example shown in FIG. 4, five or less service cards 11 or seven or more service cards 11 may be displayed. The user can further display service cards 11 by a scroll operation or the like. In addition, the service cards 11 may be displayed so as to be lined up in other modes such as a single longitudinal line, a single lateral line, and a random arrangement. Furthermore, the service card list screen is provided with a category field 11B for displaying a category. In FIG. 4, the category field 11B is displayed to the left of the card field 11A. In addition, the category field 11B displays “3D print (material)” and “3D print (crafting method)” which are examples of large classification categories and “metal”, “thermal fusion lamination”, and the like which are examples of middle classification categories.

Furthermore, the service cards 11 may include an image related to a service, specific information (for example, a service name or service identification information which identifies a service) for specifying the service, a name of the supplier who provides the service, an outline of the service, and a category of the service. In the example shown in FIG. 4, an image of a tool which is an example of an image related to a service, a character string reading “tool prototyping” as a service name or a service category, and the like are displayed. In addition, company names from Company A to Company F are displayed as names of suppliers. A plurality of suppliers may provide a service corresponding to a single service card 11. The example in FIG. 4 shows Company A and Company C cooperating with each other to provide a service of jig production. In addition, a same service or similar services may be provided by different suppliers. The example in FIG. 4 shows Company A and Company F providing a service of tool prototyping.

In addition, card data 24 as an example of service information is stored in the server memory 22 (FIG. 2). The card data 24 includes content information 24A indicating a content of a service associated with the service card, supplier information 24B which enables the user to comprehend a supplier who provides each service, and case example information 24C indicating a case example of the service provided by the supplier. Furthermore, the content information 24A, the case example information 24C, and the supplier information 24B are associated with each other via the service card 11. For example, the content information 24A, the case example information 24C, and the supplier information 24B are stored in association with card identification information. In addition, the card data 24 includes various kinds of information necessary for displaying the service card 11, for example, includes information such as an image related to a service, a configuration of a service card, and a display position of the service card.

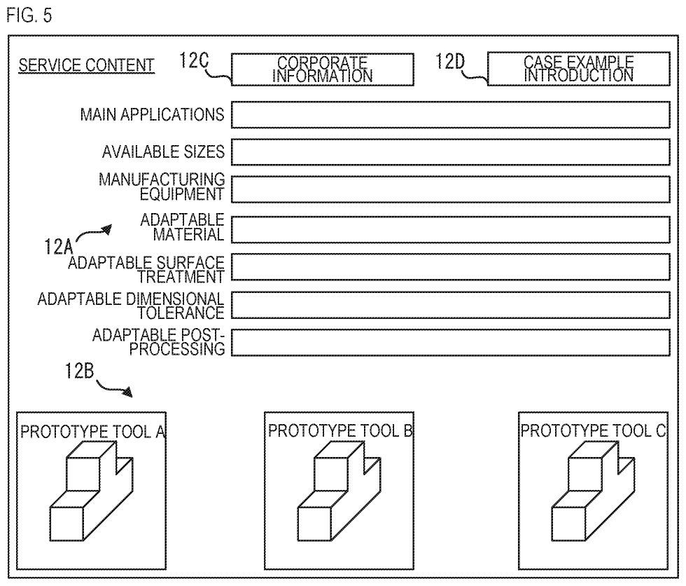

When the user performs a predetermined operation, the content information 24A is displayed by the information presenting part 38. For example, when the user performs a click operation or the like which designates the service card 11, the information presenting part 38 causes a web page in accordance with the operation to be displayed in the display part of the user terminal 40. The information presenting part 38 may cause the web page to be displayed as a new web page or displayed side by side with or on top of a web page which is already displayed on a same screen. As an example, FIG. 5 shows a service content screen which is an example of presentation of the content information 24A when tool prototyping (Company A) in FIG. 4 is selected. The service content screen is provided with a content field 12A which displays details of service contents. In the example shown in FIG. 5, “main applications”, “available sizes”, and the like are displayed in the content field 12A. In addition, images 12B of prototype tools A to C are displayed below the content field 12A in FIG. 5. Furthermore, the service content screen is provided with a supplier icon 12C for displaying supplier information 24B and a case example icon 12D for displaying the case example information 24C.

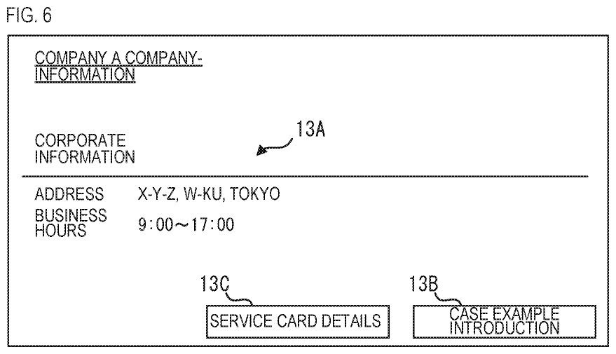

When the user performs a click operation or the like which designates the supplier icon 12C, the information presenting part 38 displays a supplier screen (FIG. 6). FIG. 6 shows a supplier screen which displays the supplier information 24B with respect to Company A. The supplier screen is provided with a corporate information field 13A which displays corporate information such as a company name, a location, business hours, a company outline, the number of employees, owned facilities, a corporate structure, a name of a representative, a corporate history, a description of business, a corporate policy, and a point of contact. In addition, in FIG. 6, a case example icon 13B for displaying the case example information 24C and a card icon 13C for displaying the content information 24A are provided below the corporate information field 13A. When the user performs a click operation or the like which designates the card icon 13C, the information presenting part 38 displays the service content screen (FIG. 5).

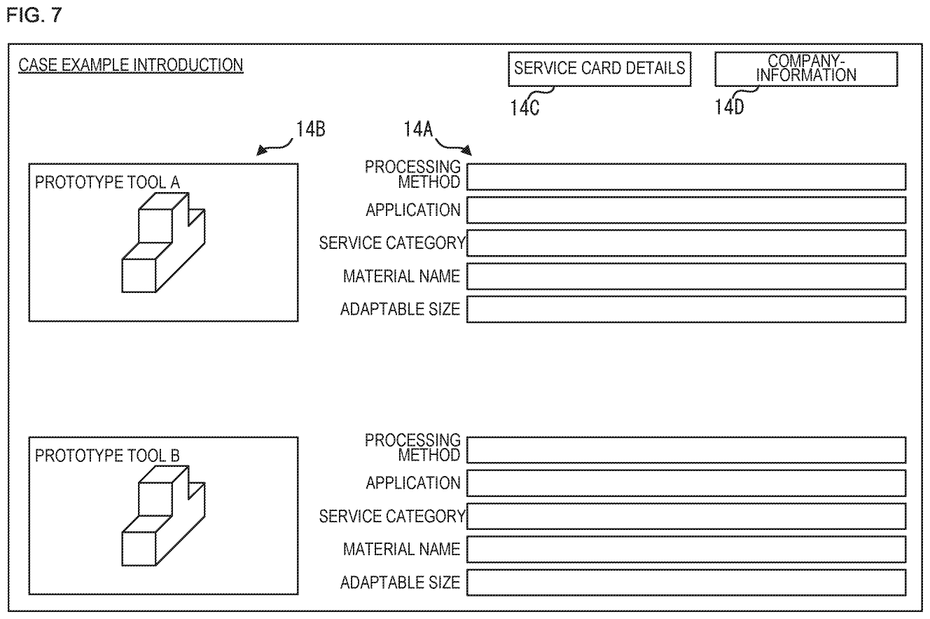

When the user performs a click operation or the like which designates the case example icon 13B, the information presenting part 38 displays a case example screen (FIG. 7). In a similar manner, when the user designates the case example icon 12D on the service content screen shown in FIG. 5, the information presenting part 38 displays the case example screen (FIG. 7). FIG. 7 shows a case example screen which displays the case example information 24C with respect to tool prototyping (Company A). The case example screen is provided with a case example content field 14A which displays contents of a case example such as a processing method, an application, and the like. In addition, in FIG. 7, images 14B of prototype tools A and B are displayed to the left of the case example content field 14A. Furthermore, the case example screen is provided with a card icon 14C for displaying the content information 24A and a supplier icon 14D for displaying the supplier information 24B. When the user designates the card icon 14C, the information presenting part 38 displays the case example screen (FIG. 7). In addition, when the user designates the supplier icon 14D, the information presenting part 38 displays the supplier screen (FIG. 6).

[Information Item Setting Means]

The information item setting part 32 sets, for each service included in the service candidate group, an information item required by the supplier to determine a provision requirement. For example, the information item setting part 32 sets an information item based on an instruction from the supplier who provides the service. Specifically, the information item setting part 32 sets an information item input by the supplier or the manager of the transaction assistance server 20 as an item for which the user can upload, input, or select data. For example, requirement data 26 stored in the server memory 22 includes information item data 26A indicating an information item of each service. In addition, each information item is included in the information item data 26A in a state of being associated with card identification information and supplier identification information. The supplier can determine whether or not the supplier is capable of meeting the provision requirement based on the information input or selected by the user with respect to the information item. Accordingly, the supplier need not repetitively ask the user to provide information. Therefore, the number of times the supplier and the user communicate with each other can be reduced, adjustment work for closing a transaction can be simplified and, at the same time, a mismatch can be prevented from being revealed after the closing of the transaction.

As an example, the supplier sends an information item corresponding to a service to the transaction assistance server 20 via the supplier terminal 60. In addition, the information item setting part 32 sets the received information item for each service in association with card identification information and includes the set information item in the information item data 26A. As an example, the information item is a name of the user, a point of contact, a name of a person in charge, a desired price, a desired delivery time, a size, a tolerance, a color, a shape, a quantity, a service category, an application, a crafting method, a material, contents of processing, a presence or absence of aftertreatment, contents of aftertreatment, a presence or absence of pretreatment, contents of pretreatment, apparatuses used in processing, or the like. The user can input or select a quantity of a desired article by pull-down or via an input apparatus. Furthermore, the user can also upload three-dimensional (3D) model data, two-dimensional (2D) model data, or the like with respect to the information item.

In addition, when the article-related service described above is included in the service candidate group, the information item setting part 32 sets model data for specifying an article and a work condition which designates a condition of work which the supplier must perform with respect to the article as the information items required by the supplier with respect to the article-related service. For example, the information item setting part 32 sets an information item for which model data such as 3D or 2D model data is to be uploaded. In this case, the request acquiring part 34 acquires data uploaded with respect to the information item set by the information item setting part 32 as request information. In addition, as the work condition, the information item setting part 32 sets items such as a method of manufacturing or a method of processing the article, a measurement method, a material of the article, a presence or absence of aftertreatment, a presence or absence of post-processing, apparatuses used to manufacture or process the article, and a measurement apparatus.

Furthermore, when the article manufacturing service described above is included in the service candidate group, the information item setting part 32 sets a manufacturing condition to be instructed with respect to manufacturing the article as the work condition. For example, the information item setting part 32 sets a manufacturing condition such as the method of manufacturing or the method of processing the article, the material of the article, the presence or absence of aftertreatment, the presence or absence of post-processing, or the apparatuses used to manufacture or process the article as the item of the work condition.

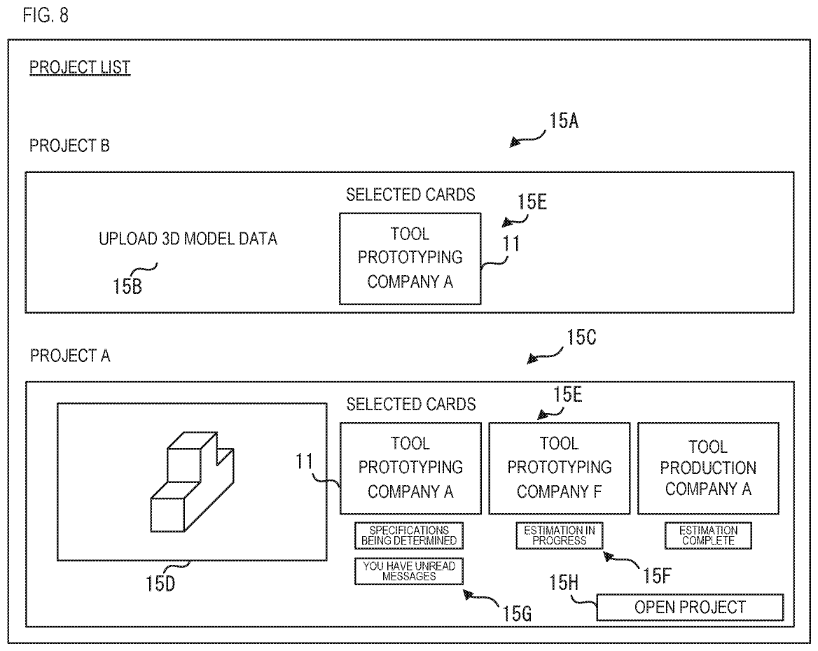

An information item will be described in specific terms with reference to FIG. 8. FIG. 8 is a project list screen which is displayed when the user completes a selection of the service card 11. The project list screen displays a new project field 15A which displays a newly created project. In addition, an upload field 15B is displayed as an information item which is set in order to cause data to be uploaded. In FIG. 8, the upload field 15B displays characters reading “Upload 3D model data” which prompt the user to perform an upload. The user can upload desired data by a drag operation and a drop operation, an operation for designating a file, or the like. On the other hand, when the user does not upload data, for example, when the user requests creation of 3D model data, the user selects an absence of data to be uploaded by not uploading data. Alternatively, the upload field 15B need not be displayed according to a setting by the information item setting part 32.

In addition, the project list screen displays an existing project field 15C which displays already-created projects. A plurality of existing projects which make up a history of past requests can be displayed in the existing project field 15C and the user can display a desired project by performing a scroll operation or the like. In addition, a thumbnail image 15D of model data uploaded by the user is displayed in the existing project field 15C. Furthermore, the new project field 15A and the existing project field 15C display a selected card field 15E which displays the service card 11 which has been selected by the user and which is associated with a project.

In FIG. 8, a status field 15F which shows a status corresponding to each service card 11 selected in the project is displayed below the existing project field 15C. The example in FIG. 8 shows a status of “specifications being determined” indicating a state during work for determining a provision requirement prior to requesting estimation, a state of “estimation in progress” indicating a state where an estimation is being requested, and a state of “estimation complete” indicating a state where an estimation has been completed. Furthermore, the status field 15F may display other statuses such as a state where provision of a service has been requested or a state where provision of a service has been completed (for example, a state where a manufactured article has been received). Each status may be indicated by an image or by a change in a display mode (for example, a change in a color, a shade, a size, or brightness) of the service card 11.

In addition, in FIG. 8, a message state field 15G indicating a state of a message using a communication function to be described later is displayed below the status field 15F. When there is a message which has not been viewed by the user, characters reading “you have unread messages” is displayed in the message state field 15G. When the user has viewed all messages, no characters are displayed in the message state field 15G. Alternatively, when the user has viewed all messages, characters reading “read” may be displayed in the message state field 15G. The state of a message may be indicated by an image or by a change in a display mode (for example, a change in a color, a shade, a size, or brightness) of the service card 11.

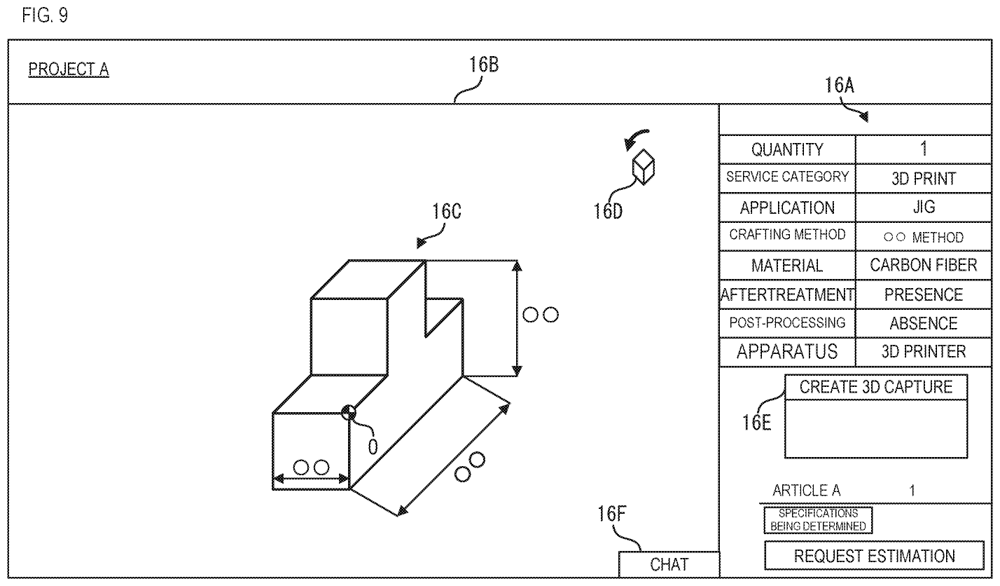

Furthermore, a project icon 15H is provided with respect to each project on the project list screen. When the user designates the project icon 15H and selects a project, a project detail screen shown in FIG. 9 is displayed. When a plurality of service cards 11 are selected in the selected project, a plurality of project detail screens may be displayed. Alternatively, project detail screens may be displayed so as to be switchable. FIG. 9 shows a project detail screen in a case where Project A has been selected. In addition, the project detail screen displays an information item field 16A and set information items are included in the information item field 16A. In FIG. 9, as information items, the information item field 16A displays items of work conditions such as a quantity, a service category, an application, a crafting method, a material, a presence or absence of aftertreatment, a presence or absence of post-processing, and apparatuses. Examples of information items other than work conditions include a point of contact, a name of a requester, case identification information (such as a management number or a case ID) for identifying a requested matter, and a model number of the article.

[Service Selection Means]

The service selecting part 33 selects a service to be provided in response to a request by the user from the service candidate group. In addition, the service selecting part 33 selects a service using service information and selection information acquired based on an instruction by the user. Specifically, the service selecting part 33 presents the user with at least a part of the services included in the service candidate group as options in selecting a service. At this point, the service selecting part 33 uses service information so that the service information is presented to the user in association with the presentation of the options. For example, the service selecting part 33 uses service information so that the service information is displayed in a part of the service card 11. In addition, the service selecting part 33 presents the service information to the user by displaying the service information in a part of the service card 11.

Furthermore, the service selecting part 33 acquires, as selection information, service specific information for specifying the service selected by the user. As an example, the service specific information is card identification information which identifies the service card 11. For example, when the user designates the service card 11, the service selecting part 33 acquires the card identification information of the designated service card 11 and selects a service. In addition, the service selecting part 33 causes the server memory 22 to store the card identification information of the designated service card 11. Specifically, on the service card list screen shown in FIG. 4, the user designates the service card 11 having been searched by referring to service information. The service card 11 is provided with a check box 11F, and when the user designates the service card 11, the check box 11F is checked. In addition, the service selecting part 33 displays an image imitating the selected service card 11 in a selected card field 11C. Furthermore, the service selecting part 33 acquires card identification information of the service card 11 in the selected card field 11C.

When an AI automatically selects a service using service information, the service selecting part 33 may select a service in accordance with service specific information which is specified by the selection by the AI. In this case, the service selecting part 33 need not present the user with the service card 11 as an option. For example, the AI may specify a service based on a keyword input to a search box 11E by the user in a state where no service card 11 is being presented. Alternatively, the AI may specify a service using information on the user (for example, a history of past transactions) in a state where the user has logged into the transaction assistance system 100 and no service card 11 is being presented. Once the AI specifies the service card 11, the service selecting part 33 displays an image imitating the selected service card 11 in the selected card field 11C. Furthermore, the service selecting part 33 acquires card identification information of the service card 11 in the selected card field 11C.

Once the selection of a service card is completed, the user designates a card determination icon 11D on the service card list screen. In addition, in response to the designation of the card determination icon 11D, the managing part 37 generates a project in association with the selection of a service by the service selecting part 33. For example, the managing part 37 causes the server memory 22 to store the card identification information in association with project identification information which identifies the project. Accordingly, the selected service is included in the generated project. Alternatively, the managing part 37 may associate the service selected by the service selecting part 33 with an existing project which has already been created.

[Request Acquiring Means]

The request acquiring part 34 acquires request information based on an instruction by the user. The request information is information for specifying a request by the user with respect to an information item which is set in association with a service selected by the service selecting part 33. For example, the request information is uploaded data having been instructed by an upload by the user on the project list screen (FIG. 8). In addition, the request information is information (for example, product specifications) having been instructed by a selection or an input by the user with respect to an information item on the project detail screen (FIG. 9). The instruction by the user is not limited to an instruction by an upload operation, a selection operation, or an input operation. The instruction by the user may be an instruction by an operation performed by the user to confirm information having been automatically selected or input by the system or to confirm initially-set information.

In addition, when an article-related service is selected, the request acquiring part 34 acquires model data and a work condition based on an instruction by the user. For example, the request acquiring part 34 acquires, as request information, 3D or 2D model data uploaded via the project list screen and a work condition selected or input via the project detail screen. As described earlier, a work condition is information which designates a condition of work to be performed by the supplier with respect to an article. For example, when an article manufacturing service is selected, the work condition is a manufacturing condition such as a manufacturing method.

[Article Image Presentation Means]

The request acquiring part 34 includes the article image presenting part 34A for presenting the user with an article image expressing an article based on model data. For example, the article image presenting part 34A causes an article image indicated by 2D model data to be displayed in the display part of the user terminal 40. In addition, when the request acquiring part 34 acquires three-dimensional model data as the model data, the article image presenting part 34A presents an image of the article as observed from a predetermined point of view in the 3D model data as an article image.

As an example, on the project detail screen shown in FIG. 9, a model display field 16B is displayed to the left of the information item field 16A in FIG. 9. In addition, a 3D model 16C is displayed in the model display field 16B. The user can change the point of view from which the 3D model 16C is observed by designating a point of view icon 16D in the model display field 16B. Alternatively, the point of view from which the 3D model 16C is observed may be changed by an operation by the user involving moving the 3D model 16C. In addition, the article image presenting part 34A presents the user with an article image representing the article as observed from the predetermined point of view based on the model data. Furthermore, when the point of view is changed, the article image presenting part 34A presents the user with an article image representing the article as observed from the changed point of view.

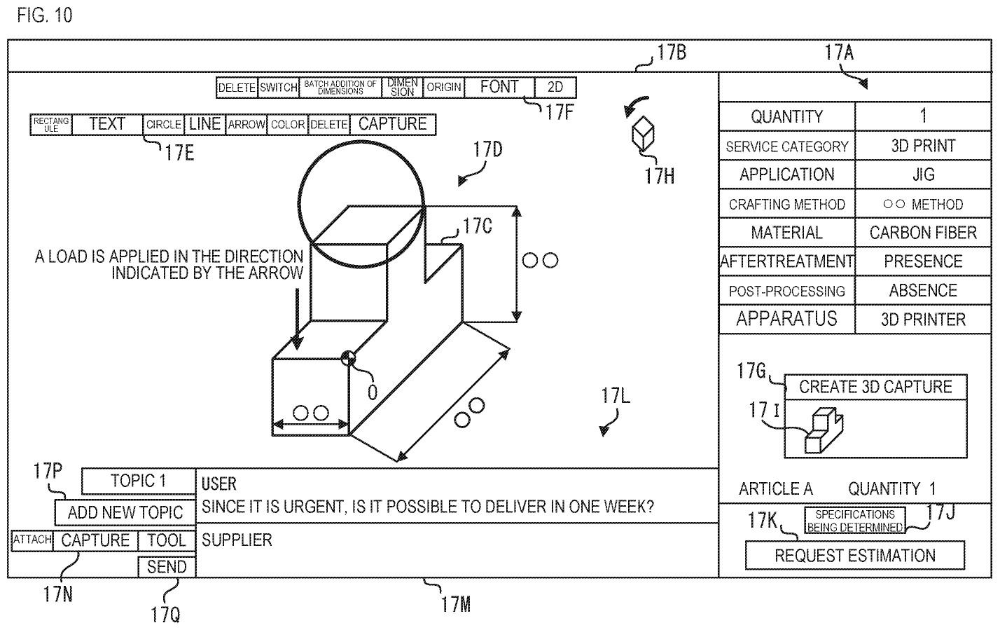

At this point, when the user wishes to create an annotation with respect to the supplier, the user designates an image creation icon 16E. In addition, the annotation data generating part 34B causes an article image screen shown in FIG. 10 to be displayed. The article image screen includes an annotation tool 17E as a function provided by the annotation data generating part 34B. Even on the article image screen, the user can change the point of view from which a 3D model 17C is observed by designating a point of view icon 17H. In addition, the article image presenting part 34A presents the user with an article image as viewed from the changed point of view. Once editing such as adding an element with respect to the article image displayed in association with the desired point of view is completed, the user operates the annotation tool 17E (for example, a capture icon included in the annotation tool 17E) to capture or extract an annotation image 17D. In addition, the article image presenting part 34A saves the annotation image 17D and causes a thumbnail image 17I of the annotation image 17D to be displayed. Subsequently, when the user designates the thumbnail image 17I of the annotation image 17D, the article image presenting part 34A causes the annotation image 17D to be displayed.

[Annotation Data Generation Means and Annotation Data Acquiring Means]

The request acquiring part 34 includes the annotation data generating part 34B and the annotation data acquiring part 34C. The annotation data generating part 34B generates, based on an instruction by the user, annotation data for displaying the annotation image 17D obtained by writing annotation information to an article image presented by the article image presenting part 34A. The annotation information is information indicating a request by the user related to at least a part of work conditions. In addition, the annotation data acquiring part 34C acquires the annotation data generated by the annotation data generating part 34B.

As an example, on the article image screen shown in FIG. 10, an image display field 17B is displayed to the left of an information item field 17A in FIG. 10. In addition, the 3D model 17C is displayed in the image display field 17B. The user adds annotation information using the annotation tool 17E and an editing tool 17F as functions provided by the annotation data generating part 34B. Specifically, the annotation data generating part 34B causes the annotation tool 17E and the editing tool 17F to be displayed on the article image screen and the user adds annotation information by designating each of the icons of the tools. Subsequently, the user captures or extracts an image and the annotation data generating part 34B generates annotation data.

As an example, the annotation tool 17E enables an addition of a rectangular element, an addition of a text, an addition of a circular or elliptic element, an addition of a linear element, an addition of an arrow element, a change in colors, a deletion of an element, and a capture or an extraction of an image to be performed. In addition, the annotation data generating part 34B can title the annotation image 17D including the article image and the annotation information and cause the server memory 22 to store the titled annotation image 17D. Furthermore, the annotation image 17D may be attached to a message created by the communication function provided by the communication part 36A. In this case, when the annotation image 17D is captured or extracted, the annotation data generating part 34B causes the communication part 36A to attach the annotation image 17D to the message. In addition, the editing tool 17F enables a deletion of design/manufacturing information, switching between displaying and hiding design/manufacturing information, batch addition of dimensions, individual addition of a dimension, setting of an origin, a change to a font size, and creation of a 2D image to be performed. The design/manufacturing information is information to be used in design or manufacturing such as dimensions, an origin, or a tolerance.

In the example shown in FIG. 10, an addition of a circular element, an addition of an arrow element, and an addition of a text are performed. Using a text reading “A load is applied in the direction indicated by the arrow” and the arrow element, the user can inform the supplier of a position and a direction where a load is applied. Furthermore, using the circular element, the user can inform the supplier of a position of a surface to be processed. The point of view may be made changeable after presentation of the annotation image 17D by having the user designate the point of view icon 17H in the image display field 17B. In this case, the article image presenting part 34A once again presents an image of the article as observed from the different point of view.

Once editing of the article image is completed, the user designates a capture icon of the annotation tool 17E. In addition, the annotation data generating part 34B generates annotation data for displaying the annotation image 17D including annotation information for each element and the like. At this point, the annotation data generating part 34B generates the annotation data so as to include point of view information which specifies a point of view. Furthermore, the annotation data generating part 34B causes the server memory 22 to store the generated annotation data. Since the annotation data includes point of view information, when the supplier views the annotation image 17D, the annotation image 17D can be displayed from the same point of view as the user's point of view. In FIG. 10, a status field 17J is displayed below an image creation icon 17G and a character string reading “specifications being determined” is displayed as a state corresponding to the service card 11 of the selected project. In addition, a request icon 17K for requesting the supplier to provide an estimation is displayed below the status field 17J. The user requests the supplier to provide an estimation by designating the request icon 17K.

Alternatively, an annotation program other than the assistance program PG may cause a user terminal control part 45 or the server control part 23 to function as the article image presenting part 34A or the annotation data generating part 34B. Furthermore, the article image presenting part 34A or the annotation data generating part 34B may be provided in an external server other than the transaction assistance server 20. In this case, the annotation data acquiring part 34C acquires the annotation data generated by the annotation data generating part 34B from the external server.

[Determining Means]The determining part 36 determines a provision requirement for the supplier to provide a service based on the request information acquired by the request acquiring part 34. For example, when input of request information by the user is completed, the determining part 36 notifies the supplier terminal 60 of the supplier associated with the project via the service card 11 of a determination request for determining the provision requirement. The supplier terminal 60 can be notified of the determination request by a message created by the communication function provided by the communication part 36A or other means of communication such as e-mail. The supplier refers to the request information, creates estimation contents, and performs an operation to provide the user with an estimation reply. In addition, the determining part 36 notifies the user terminal 40 of the estimation reply. On the user terminal 40, the user confirms, for example a written estimate, as the reply to the determination request by downloading it from the transaction assistance server 20. Subsequently, once the user confirms the estimation contents included in the written estimate and performs a determination operation such as determination of a requirement or placement of an order, the determining part 36 determines the provision requirement and saves the determination information in the server memory 22.

As an example, once the user designates the request icon 17K and completes input of request information, the determining part 36 notifies the supplier terminal 60 of a request for estimation as a determination request. In addition, the determining part 36 may notify the supplier terminal 60 of project identification information of a project corresponding to the request for estimation. When there are a plurality of suppliers associated with the project, the determining part 36 notifies the supplier terminals 60 of the plurality of suppliers of the determination request.

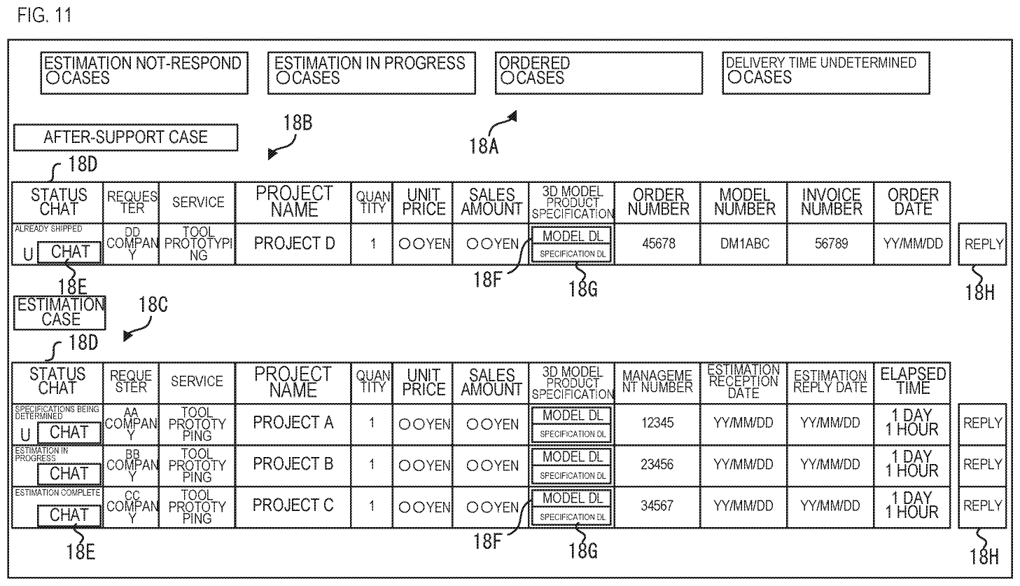

The supplier can confirm notifications by logging into the transaction assistance system 100 via the supplier terminal 60. As an example, FIG. 11 shows a case list screen which is displayed upon login to the transaction assistance system 100. The case list screen displays a number-of-cases field 18A, and a support case field 18B and an estimation case field 18C are displayed below the number-of-cases field 18A in FIG. 11. In addition, the supplier can confirm the notification by checking the estimation case field 18C. A plurality of projects may be displayed in the support case field 18B and the estimation case field 18C, and the supplier can cause a desired project to be displayed on the case list screen by a scroll operation or the like.

As an example, the number-of-cases field 18A displays the number of projects for which the supplier has not provided an estimation, the number of projects for which an estimation work is in progress, the number of projects of which a provision requirement has been determined and for which a request has been received from the user, and the number of projects for which a request has been received from the user but a delivery time has not been determined.

The support case field 18B displays projects in which support work is required after the provision of service and case items corresponding to the projects. The case items include a name of a requester and information related to the project including contents of a service such as “tool prototyping”. In addition, the case items include a present status 18D of the project. In the example shown in FIG. 11, statuses of “already shipped”, “specifications being determined”, “estimation in progress”, and “estimation complete” are displayed as the status 18D. Furthermore, in FIG. 11, a supplier chat icon 18E and information indicating a presence or absence of an unread message (for example, the letter “U” which is displayed when there is an unread message) are displayed below the status 18D. The supplier can use the communication function provided by the communication part 36A by designating the supplier chat icon 18E.

Furthermore, case items include a data download icon 18F for downloading model data and a specification download icon 18G for downloading specifications. The supplier can download model data having been uploaded by the user from the transaction assistance server 20 to the supplier terminal 60 by designating the data download icon 18F. In addition, the supplier can download specifications created by the supplier or the transaction assistance system 100 from the transaction assistance server 20 to the supplier terminal 60 by designating the specification download icon 18G. Furthermore, a reply icon 18H is displayed to the right of each project in FIG. 11. The supplier can create a reply with respect to a support request by designating the reply icon 18H.

The estimation case field 18C also displays the present status 18D, the supplier chat icon 18E, information indicating a presence or absence of an unread message, the data download icon 18F, the specification download icon 18G, and the reply icon 18H. In addition, unlike in the support case field 18B, the case items corresponding to the projects in the estimation case field 18C include an estimation reception date, an estimation reply date, an elapsed time, and the like. The determining part 36 notifies the supplier of a determination request by causing the estimation case field 18C to display a project. The determining part 36 may notify the determination request by another notification method in addition to or in place of the estimation case field 18C. The supplier can create a reply to an estimation request as a determination request by designating the reply icon 18H.

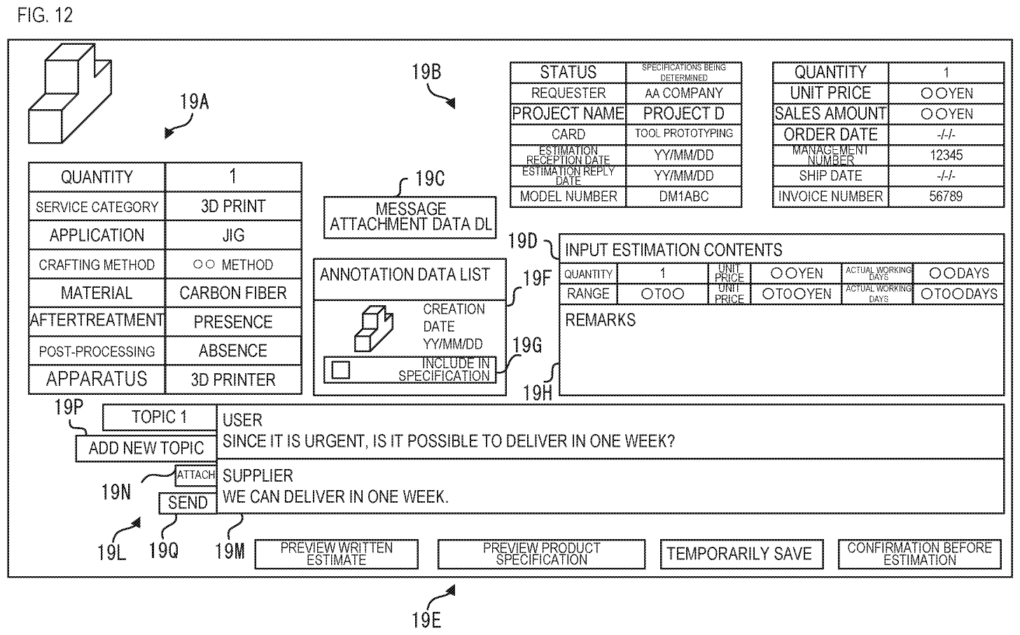

As an example, the supplier can create a reply on a case detail screen shown in FIG. 12. When the reply icon 18H is designated, the determining part 36 causes the case detail screen to be displayed and causes the case detail screen to display a request information field 19A. In addition, the determining part 36 presents the supplier with request information acquired by the request acquiring part 34 by causing the request information field 19A to display the request information. The user has selected or input request information with respect to an information item required by the supplier to determine the provision requirement. Therefore, the supplier can guide the user to select or input information which the supplier needs. Accordingly, the supplier can reduce the possibility of an occurrence of a situation where the supplier makes an inquiry to the user.

In addition, a project content field 19B which indicates contents of a project is displayed at upper right in FIG. 12. The supplier can recognize a status of the project or the like by confirming the project content field 19B. Furthermore, an attached data download icon 19C for downloading data attached to a message such as an article image attached by the communication part 36A is displayed in a center portion in FIG. 12. The supplier can download the attached data from the transaction assistance server 20 to the supplier terminal 60 by designating the attached data download icon 19C.

Furthermore, an input field 19D to be used by the supplier to input estimation contents is displayed below the project content field 19B in FIG. 12. The determining part 36 causes the input field 19D to display items for which estimation contents are to be input by the supplier. In the example shown in FIG. 12, the supplier inputs a unit price of an article, actual working days as a period of time necessary for provision, and necessary remarks as the estimation contents. A quantity is input when a unit price in accordance with the quantity is available. For example, the supplier inputs the quantity when unit prices differ between one to five units and five or more units. In the example shown in FIG. 12, the unit price and the actual working days are only input with respect to a quantity of one. However, the input field 19D may be configured such that a unit price and actual working days are to be input for each of a plurality of quantity conditions or ranges. In addition, the supplier can input a character string indicating a reply, a question, a proposal, or the like with respect to the user in a remarks field 19H.

In the input field 19D, the supplier can input a quantity, a unit price, actual working days, and the like in a mode of designating a range. For example, with respect to actual wording days, a scheduled period until the article can be provided may vary. In such a case, the supplier can input a range such as five to six days. Accordingly, even when input contents vary, an estimation can be input without having to inform the user that the input contents vary.

In addition, an icon field 19E is displayed in a lower part in FIG. 12. By designating each icon, for example, the supplier can display a preview of a written estimate in the display part of the supplier terminal 60. Furthermore, due to the designation of an icon by the supplier, a preview of product specifications can be displayed, input estimation contents can be temporarily saved, and estimation contents can be displayed for confirmation. Once the estimation contents are displayed and final confirmation is completed, the supplier performs an estimation reply operation with respect to the user on a screen (not illustrated) on which the estimation contents are displayed. In addition, the determining part 36 saves the written estimate as the estimation contents and product specifications indicating the provision requirement in the server memory 22 and notifies the user terminal 40 of the estimation reply.

Furthermore, the determining part 36 determines the provision requirement based on an instruction for requirement determination by at least any one of the user and the supplier. In addition, the determining part 36 saves determination information indicating the determined provision requirement in a predetermined server memory 22 so that the user and the supplier can confirm the determination information. For example, in order to reply to the estimation reply, the user downloads the written estimate and the product specifications from the transaction assistance server 20 to the user terminal 40 and confirms the written estimate and the product specifications. Furthermore, after confirming the written estimate and the product specifications, the user performs a determination operation as an instruction of requirement determination. In accordance with the determination operation, the determining part 36 determines the provision requirement and saves the product specifications as determination information indicating the determined provision requirement in the server memory 22 so that the user and the supplier can confirm the product specifications. In addition, the determining part 36 saves the written estimate in the server memory 22 so that the user and the supplier can confirm the written estimate together with the product specifications.

As a result of the confirmation, as request information, the user may upload a revised written estimate or revised product specifications or attach the revised written estimate or the revised product specifications to a message. The revised written estimate or the revised product specifications is acquired by the request acquiring part 34 and presented to the supplier by the determining part 36 in a similar manner to other request information. On the supplier terminal 60, the supplier downloads the revised written estimate or the revised product specifications from the transaction assistance server 20 and confirms the revised written estimate or the revised product specifications. Furthermore, after confirming the revised written estimate or the revised product specifications, the supplier performs a determination operation as an instruction of requirement determination. In accordance with the determination operation, the determining part 36 saves the product specifications as determination information indicating the determined provision requirement in the server memory 22 so that the user and the supplier can confirm the product specifications. In addition, the determining part 36 saves the written estimate in the server memory 22 so that the user and the supplier can confirm the written estimate together with the product specifications.

[Annotation Image Presentation Means]

The determining part 36 includes the annotation image presenting part 36B which presents the supplier with the annotation image 17D (FIG. 10) based on acquired annotation data. For example, in FIG. 12, an annotation data field 19F is displayed below the attached data download icon 19C. The supplier designates a thumbnail image indicating the annotation image 17D displayed in the annotation data field 19F. In addition, the annotation image presenting part 36B presents the annotation image 17D to the supplier by causing the annotation image 17D to be displayed in the display part of the supplier terminal 60. In this case, the annotation image 17D presented by the annotation image presenting part 36B is displayed in a state after being edited by the user on the article image screen shown in FIG. 10 and being stored in the server memory 22 by the annotation data generating part 34B.

Specifically, the annotation image presenting part 36B presents the supplier with the annotation image 17D from a point of view corresponding to the point of view information included in the annotation data stored in the server memory 22. For example, the annotation image presenting part 36B refers to the point of view information in the annotation data and presents the annotation image 17D so as to include an article image as viewed from a point of view which is specified by the point of view information. The annotation image 17D includes information added by the user by editing such as an added element and an added text. Therefore, the annotation image presenting part 36B displays the information at the same time as the article image.

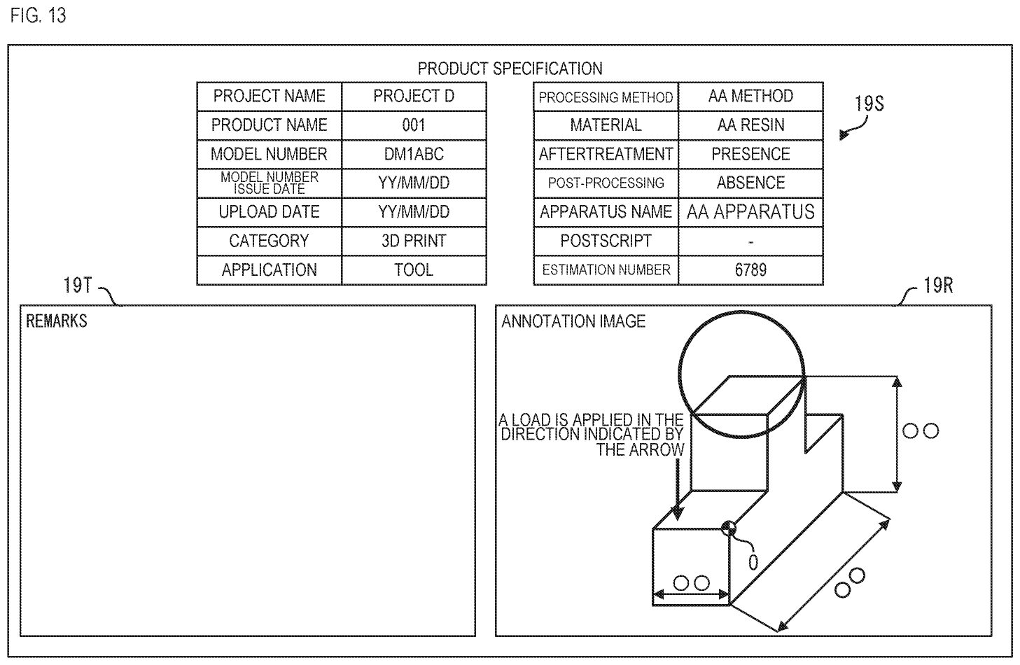

In addition, the annotation data field 19F includes an addition icon 19G for adding the annotation image 17D to the product specifications. When the supplier designates the addition icon 19G, the determining part 36 adds the annotation image 17D to the product specifications. As an example, the determining part 36 saves the product specifications in the server memory 22 so that the annotation image 17D is included in an annotation image field 19R in a lower part of the product specifications shown in FIG. 13. Accordingly, the annotation image 17D stored in the server memory 22 is attached to the product specifications. At this point, when there are a plurality of annotation images 17D, the supplier may select the annotation image 17D to be attached to the product specifications. The product specifications refer to data indicating work conditions and may also be called article specifications, specifications, manufacturing specifications, processing specifications, or the like. In the example shown in FIG. 13, the product specifications include a project content field 19S which shows a provision requirement and project contents and a remarks field 19T. The remarks field 19T shows contents of the remark input by the supplier to the input field 19D of the case detail screen (FIG. 12).

Furthermore, the annotation image presenting part 36B may be capable of changing a presentation mode of the annotation image 17D so that an article is displayed from a point of view which differs from the point of view information included in the annotation data based on an instruction by the supplier. For example, together with the annotation image 17D, the annotation image presenting part 36B displays the point of view icon 16D such as that shown in FIG. 9. The supplier can change the point of view by designating the point of view icon 16D. The annotation image presenting part 36B causes an article image of the article as observed from the changed point of view to be displayed. At this point, a presentation mode of the information added by the user by editing may be changed. Specifically, the annotation image presenting part 36B may change a position or a posture of an element or may hide the element.

For example, when a portion indicated by an arrow element is changed to an unobservable point of view by the supplier, the annotation image presenting part 36B may hide the arrow element or change the position or the posture of the element. In this case, the annotation data generating part 34B may generate new annotation data and save the new annotation data in the server memory 22 or may overwrite and save the annotation data. The annotation image presenting part 36B presents the supplier with the annotation image 17D from a point of view corresponding to the point of view information included in the annotation data.

[Communication Means]

The determining part 36 includes the communication part 36A which provides a function for communication (also referred to as a communication function in the present specification) for adjusting a provision requirement based on request information. The communication part 36A provides the communication function to the user and the supplier set in association with a selected service. As an example, the communication function is a function for mutually transmitting texts, sound, images, or other data between the user and the supplier.

For example, a user chat icon 16F is displayed in a lower part of the project detail screen shown in FIG. 9. When the user designates the user chat icon 16F, the communication part 36A causes a user chat region 17L for inputting or uploading data to be transmitted from the user to the supplier to be displayed. As an example, the communication part 36A causes the user chat region 17L to be displayed as shown in FIG. 10. In the example shown in FIG. 10, the user chat region 17L includes a user message field 17M, a user chat tool 17N, a user topic tool 17P, and a user transmission icon 17Q. The user can input a message to the user message field 17M and a message input by the supplier is displayed in the user message field 17M. Accordingly, the supplier and the user can communicate with each other.

In addition, using the user chat tool 17N, the user can select data and attach the data to a message, capture or extract an article image and save the article image, and activate the annotation tool 17E. Furthermore, the user can use the user topic tool 17P to create a new topic. The communication part 36A displays messages between the user and the supplier for each topic. Therefore, the supplier and the user can communicate with each other via messages for each topic. In addition, once the user creates a message, the user designates the user transmission icon 17Q and the communication part 36A transmits the message to the supplier.

The supplier chat icon 18E is displayed on a screen displayed on the supplier terminal 60 such as the case list screen shown in FIG. 11. When the supplier designates the supplier chat icon 18E, the communication part 36A causes a supplier chat region 19L for inputting or uploading data to be transmitted from the supplier to the user to be displayed. As an example, the communication part 36A causes the supplier chat region 19L to be displayed as shown in FIG. 12. In the example shown in FIG. 12, the supplier chat region 19L includes a supplier message field 19M, a supplier chat tool 19N, a supplier topic tool 19P, and a supplier transmission icon 19Q. The supplier can input a message to the supplier message field 19M and a message input by the user is displayed in the supplier message field 19M. Accordingly, the supplier and the user can communicate with each other.

In addition, using the supplier chat tool 19N, the supplier can select data and attach the data to a message. Furthermore, the supplier can use the supplier topic tool 19P to create a new topic. The communication part 36A displays messages between the user and the supplier for each topic. In addition, once the supplier creates a message, the supplier designates the supplier transmission icon 19Q and the communication part 36A transmits the message to the user.

In addition, when the provision requirement includes at least any one of a delivery time and an estimation related to a service as an acceptance condition of the supplier, the communication part 36A provides a communication function so as to give the supplier an opportunity to present the acceptance condition to the user. In the example shown in FIG. 12, a question message input by the user and related to the delivery time and a reply message input by the supplier are displayed in the supplier message field 19M. In this case, “1 week” is the acceptance condition of the supplier and the communication part 36A transmits a message including the acceptance condition to the user. Accordingly, the communication part 36A gives the supplier an opportunity to present the acceptance condition to the user. The delivery time includes the actual wording days described earlier.

In addition, an estimation as the acceptance condition includes a quantity, a unit price, a quality, a total price, or the like and the communication part 36A transmits a message including the estimation to the user. Alternatively, the communication part 36A may transmit data indicating contents of the delivery time or contents of the estimation to the user by attaching the data to a message. The mutual communication of messages by the communication part 36A may be performed directly in real time between the user terminal 40 and the supplier terminal 60 or performed via the transaction assistance server 20. In addition, a communication program other than the assistance program PG may cause the user terminal control part 45 or the server control part 23 to function as the communication part 36A. Furthermore, the communication part 36A may be provided in an external server other than the transaction assistance server 20. In this case, the mutual communication of messages is performed via the external server.

[Management Means]

The managing part 37 generates a project in association with the selection of a service by the service selecting part 33. In addition, the managing part 37 separately manages communication via the communication part 36A per project so that each of the user and the supplier can select a project and engage in communication. As an example, the managing part 37 generates project data 25 (FIG. 2), attaches project identification information to the project data 25, and causes the server memory 22 to store the project data 25. In addition, the managing part 37 includes message data 25E in the project data 25 together with request information 25A, determination information 25B, model data 25C, and annotation data 25D. Furthermore, the managing part 37 includes the case items described earlier as contents of the project in the project data 25.

When the user or the supplier selects a project and uses the communication function, the communication part 36A uses the project identification information of the selected project to refer to the message data 25E included in the project data 25. Accordingly, the communication part 36A can present the user and the supplier with a message created in the selected project. In addition, when the user or the supplier creates a new message, the managing part 37 includes the new message in the message data 25E and causes the server memory 22 to store the message data 25E. Accordingly, the managing part 37 separately manages communication per project.

[Storage Means]

As shown in FIG. 2, the server memory 22 stores the assistance program PG, the card data 24, the project data 25, and the requirement data 26. The card data 24 is created by the supplier or the manager of the transaction assistance server 20 and, in the example shown in FIG. 2, includes the content information 24A, the supplier information 24B, and the case example information 24C. In addition, the project data 25 includes the request information 25A, the determination information 25B, the model data 25C, the annotation data 25D, and the message data 25E. The requirement data 26 includes the information item data 26A.

[User Terminal and Supplier Terminal]

The user terminal 40 includes the user terminal control part 45 which controls the user terminal 40 and a user terminal memory 44 which is an example of a user terminal storage part storing a control program (not illustrated). The user terminal control part 45 is configured as a computer combining a processor which executes various calculation processing steps and operation control in accordance with a predetermined program with other peripheral apparatuses. In addition, the user terminal 40 includes a user terminal display 46 which is an example of a display part for displaying a web page generated by the transaction assistance server 20.

Furthermore, the user terminal 40 includes a user terminal communicating part 47 as an example of a communication apparatus which transmits and receives data to and from the transaction assistance server 20. The user terminal 40 may directly transmit and receive data to and from the supplier terminal 60 using the user terminal communicating part 47. In addition, the user terminal 40 includes an input part (not illustrated) which is an example of an input apparatus including a keyboard or various switches for inputting commands and data. Alternatively, a display part such as a touch panel may function as the input part.

The supplier terminal 60 includes a supplier terminal control part 65 which controls the supplier terminal 60 and a supplier terminal memory 64 which is an example of a supplier terminal storage part storing a control program (not illustrated). The supplier terminal control part 65 is configured as a computer combining a processor which executes various calculation processing steps and operation control in accordance with a predetermined program with other peripheral apparatuses. In addition, the supplier terminal 60 includes a supplier terminal display 66 which is an example of a display part for displaying a web page generated by the transaction assistance server 20.

Furthermore, the supplier terminal 60 includes a supplier terminal communicating part 67 as an example of a communication apparatus which transmits and receives data to and from the transaction assistance server 20. The supplier terminal 60 may directly transmit and receive data to and from the user terminal 40 using the supplier terminal communicating part 67. In addition, the supplier terminal 60 includes an input part (not illustrated) which is an example of an input apparatus including a keyboard or various switches for inputting commands and data. Alternatively, a display part such as a touch panel may function as the input part.

The user terminal control part 45 and the supplier terminal control part 65 are similar to the server control part 23 in terms of being configured as a computer including a processor such as a CPU. In addition, the user terminal memory 44 and the supplier terminal memory 64 are similar to the server memory 22 in terms of being configured as a computer-readable non-transitory storage medium including a ROM, an HDD, or the like. As such, detailed descriptions of the user terminal control part 45 and the supplier terminal control part 65, and the user terminal memory 44 and the supplier terminal memory 64, will be omitted.

[Transaction Assistance Flow]

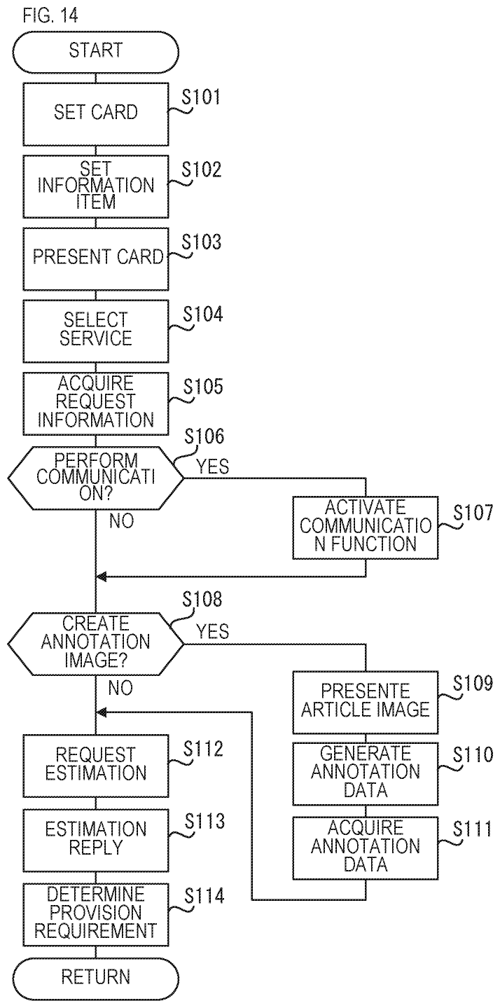

Referring to FIG. 14, an example of a transaction assistance flow by the transaction assistance system 100 will be described. First, the supplier or the manager of the transaction assistance server 20 inputs a service to be included in a service candidate group and service information corresponding to the service to the transaction assistance server 20. In addition, the service setting part 31 sets, in association with the service information, the service card 11 as information which enables the user to comprehend the input service (S101). Accordingly, the service setting part 31 sets, in association with service information of each service, a service candidate group including a plurality of services.

In addition, the supplier or the manager of the transaction assistance server 20 inputs an information item for each set service card 11. Furthermore, the information item setting part 32 sets the input information item as an item for which the user can input or select request information (S102). Accordingly, the information item setting part 32 sets an information item for each service included in the service candidate group. Next, the service selecting part 33 causes the service candidate group including a plurality of the service cards 11 to be displayed on the service card list screen (FIG. 4) of a web page accessed by the user (S103). Accordingly, the service selecting part 33 presents the user with each service included in the service candidate group as an option in selecting a service.

The user refers to the service content screen (FIG. 5), the supplier screen (FIG. 6), or the case example screen (FIG. 7) which is displayed by performing a search using a keyword or by designating one of the service cards 11. In addition, the user selects the service card 11 associated with a desired service from among the plurality of service cards 11 being presented. In response to the selection, the service selecting part 33 acquires service specific information (for example, card identification information) for specifying the service selected by the user. Furthermore, the service selecting part 33 selects the service specified by the service specific information from the service candidate group (S104).

Once the selection of a service card is completed, the user designates the card determination icon 11D on the service card list screen. In addition, the managing part 37 generates a project in association with the selection of a service by the service selecting part 33. Accordingly, the selected service is included in a project. In addition, the project list screen (FIG. 8) including the project generated by the managing part 37 is displayed on the user terminal 40. Furthermore, when the user selects a project on the project list screen, the project detail screen (FIG. 9) is displayed. The user uploads 3D model data on the project list screen and selects or inputs request information with respect to information items displayed on the project detail screen.

By acquiring the 3D model data and information selected or input by the user, the request acquiring part 34 acquires request information based on an instruction by the user (S105). Accordingly, communication between the user and the supplier can be facilitated. When desiring to communicate with the supplier (YES in S106), the user designates the user chat icon 16F on the project detail screen. In addition, the communication part 36A activates the communication function (S107) and causes the user chat region 17L to be displayed (FIG. 10). Once the user inputs a message and designates the user transmission icon 17Q, the communication part 36A transmits the message to the supplier.

In addition, even when the user does not desire to communicate with the supplier (NO in S107), the user may desire to create the annotation image 17D (YES in S108). In this case, the user designates the image creation icon 16E on the project detail screen. Furthermore, the article image presenting part 34A causes the article image screen (FIG. 10) to be displayed. The article image screen includes the annotation tool 17E as a function provided by the annotation data generating part 34B. On the article image screen, the user changes the point of view from which the 3D model 17C is observed. In addition, the article image presenting part 34A causes an article image in a state of being observed from the changed point of view to be displayed (S109).

Furthermore, the user adds necessary elements using the annotation tool 17E. Subsequently, the user operates the annotation tool 17E to capture or extract an image and the annotation data generating part 34B generates annotation data for displaying the annotation image 17D (S110). In addition, the annotation data acquiring part 34C acquires the generated annotation data (S111). The communication with the supplier and the creation of the annotation image 17D can be performed at any time by the user. In addition, communication by the communication function and the creation of annotation data may be performed in any order.

Subsequently, once the user designates the request icon 17K and completes input of request information, the determining part 36 notifies the supplier terminal 60 of a request for estimation as a determination request (S112). The supplier comprehends the project in which a request for estimation has been made on the case list screen (FIG. 11). In addition, the supplier designates the reply icon 18H and the determining part 36 causes the case detail screen (FIG. 12) to be displayed. The request information field 19A is displayed on the case detail screen and a situation where the supplier asks the user for further information is avoided. Accordingly, an accurate request by the user can be presented to the supplier with minimal processing. When the supplier designates a thumbnail image indicating the annotation image 17D displayed in the annotation data field 19F on the case detail screen, the annotation image presenting part 36B displays the annotation image 17D. In addition, the supplier can also communicate with the user using the supplier chat region 19L.

The supplier inputs estimation contents via the input field 19D. In addition, the supplier may designate the addition icon 19G to add the annotation image 17D to product specifications. Once the estimation is completed, the supplier performs an operation of an estimation reply with respect to the user. In addition, the determining part 36 saves a written estimate as the estimation contents and the product specifications indicating a provision requirement in the server memory 22 and notifies the user terminal 40 of the estimation reply (S113). The user downloads the written estimate and the product specifications from the transaction assistance server 20 to the user terminal 40 and confirms the written estimate and the product specifications. If all is satisfactory, the user performs a determination operation as an instruction of requirement determination. In addition, the determining part 36 determines the provision requirement (S114) and saves the product specifications as determination information indicating the determined provision requirement in the server memory 22 so that the user and the supplier can confirm the product specifications. Accordingly, the processing ends. Furthermore, the determination operation by the user may be an operation for ordering the provision of a service. The operation can be performed on an order screen (not illustrated) displayed by the determining part 36.

According to the transaction assistance system 100 related to the embodiment described above, a service desired by the user and a service which can be provided by the supplier can be matched with each other. Therefore, a service which the supplier is capable of providing and a service desired by the user can be made to match each other to simplify adjustment work for closing a transaction and, at the same time, a mismatch can be prevented from being revealed after the closing of the transaction.

While the present invention has been described above with reference to each embodiment, the present invention is not limited to the above embodiments. Rather, it is to be understood that the present invention also includes inventions modified without departing from the scope of the present invention and inventions equivalent to the present invention. In addition, each embodiment and each modification can be appropriately combined without departing from the scope of the present invention.

For example, a part of each functional part included in the transaction assistance server 20 may be provided in at least one of the user terminal 40 and the supplier terminal 60. As an example, the request acquiring part 34 may be provided in the user terminal 40 and the user terminal 40 may transmit acquired request information to the transaction assistance server 20 or the supplier terminal 60. As another example, the determining part 36 may be provided in the supplier terminal 60 and the supplier terminal memory 64 may save therein determination information indicating a determined provision requirement. In this case, the supplier terminal 60 may transmit the determination information to the transaction assistance server 20 or the supplier terminal 60.

In addition, when a part of each functional part included in the transaction assistance server 20 is provided in at least one of the user terminal 40 and the supplier terminal 60, the assistance program PG and the control program of at least one of the user terminal 40 and the supplier terminal 60 cooperate with each other to function as a computer program of the transaction assistance system 100. Furthermore, the transaction assistance system 100 is constituted of the transaction assistance server 20 and at least one of the user terminal 40 and the supplier terminal 60.

In addition, the transaction assistance server 20 may further include a function of automatically creating estimation contents. The supplier can confirm the estimation created by the function and perform an estimation reply after making necessary modifications.

In the present specification, an article may be an object constructed by combining a plurality of parts or a single whole object. Alternatively, an article may be an assembly of modules, units, or the like which exhibit functions by being incorporated into a finished product.

A part of or all of the embodiments described above may be described as, but not limited to, the following supplementary notes.

[Supplementary Note 1]

A server apparatus determining a provision requirement for providing a service between a supplier providing the service and a user demanding provision of the service in order to assist with closing of a transaction between the supplier and the user, the server apparatus comprising:

a service setting unit configured to set, in association with service information of each service used in relation to selection of the service, a service candidate group including a plurality of services which are providable to the user;

an information item setting unit configured to set, for each service included in the service candidate group, an information item necessary for the supplier in order to determine the provision requirement;

a service selection unit configured to select the service provided in response to a demand by the user from the service candidate group using the service information and selection information acquired based on an instruction by the user;

a request acquiring unit configured to acquire, based on an instruction by the user, request information for specifying a request by the user with respect to the information item set in association with the selected service; and

a determining unit configured to determine the provision requirement based on the acquired request information.

### REFERENCE SIGNS LIST

22: server memory (storage unit)
23: server control part (computer)
31: service setting part (service setting unit)
32: information item setting part (information item setting unit)
33: service selection part (service selection unit)
34: request acquiring part (request acquiring unit)
34A: article image presenting part (article image presenting unit)
34B: annotation data generating part (annotation data generating unit)
34C: annotation data acquiring part (annotation data acquiring unit)
36: determining part (determining unit)
36A: communication part (communication unit)
36B: annotation image presenting part (annotation image presenting unit)
37: managing part (managing unit)
100: transaction assistance system
PG: assistance program (computer program)

1. A transaction assistance system determining a provision requirement for providing a service between a supplier providing the service and a user demanding provision of the service to assist with closing of a transaction between the supplier and the user, the transaction assistance system comprising:
a processor, wherein
the processor is configured to set, in association with service information of each service used in relation to selection of the service, a service candidate group including a plurality of services which are providable to the user,
the processor is configured to set an item of a work condition for designating a condition of work to be performed by the supplier, in association with each service included in the service candidate group, as an information item necessary for the supplier in order to determine the provision requirement,
the processor is configured to select a target service provided in response to a demand by the user from the service candidate group using the service information and selection information acquired based on an instruction by the user,
the processor is configured to present the user with the item of the work condition set in association with the target service in a format in which information is selectable or inputable by the user with respect to each item of the work condition,
the processor is configured to acquire the information, which is selected or input by the user with respect to the item of the work condition set in association with the target service as request information for specifying a request by the user, and
the processor is configured to determine the provision requirement based on the acquired request information.

2-5. (canceled)

6. The transaction assistance system according to claim 1, wherein
an article-related service which requires the work by the supplier related to an article is included in the service candidate group, and
the processor sets, as the information item required by the supplier with respect to the article-related service, the item of the work condition which designates the condition of the work to be performed by the supplier with respect to the article.

7. The transaction assistance system according to claim 6, wherein,
as the article-related service, an article manufacturing service which requires manufacturing of the article by the supplier as the work is included in the service candidate group, and
the processor sets an item of a manufacturing condition to be instructed with respect to the manufacturing of the article as the item of the work condition.

8-11. (canceled)

12. The transaction assistance system according to claim 1, wherein the processor sets the item of the work condition in association with the service provided by the supplier based on an instruction from the supplier.

13. A computer-readable non-transitory storage medium storing a computer program for a transaction assistance system which includes a computer and which is configured to determine a provision requirement for providing a service between a supplier providing the service and a user demanding provision of the service to assist with closing of a transaction between the supplier and the user, the computer program causing the computer to function as:
set, in association with service information of each service used in relation to selection of the service, a service candidate group including a plurality of services which are providable to the user;
set an item of a work condition for designating a condition of work to be performed by the supplier, in association with each service included in the service candidate group, as an information item necessary for the supplier in order to determine the provision requirement;
to select a target service provided in response to a demand by the user from the service candidate group using the service information and selection information acquired based on an instruction by the user;
present the user with the item of the work condition set in association with the target service in a format in which information is selectable or inputable by the user with respect to each item of the work condition;
acquire the information which is selected or input by the user with respect to the item of the work condition set in association with the target service as request information for specifying a request by the user; and
determine the provision requirement based on the acquired request information.

14. A method of control for a transaction assistance system which includes a computer and which is configured to determine a provision requirement for providing a service between a supplier providing the service and a user demanding provision of the service to assist with closing of a transaction between the supplier and the user, the method of control causing the computer to:
set, in association with service information of each service used in relation to selection of the service, a service candidate group including a plurality of services which are providable to the user;
set an item of a work condition for designating a condition of work to be performed by the supplier, in association with each service included in the service candidate group, as an information item necessary for the supplier in order to determine the provision requirement;
select a target service provided in response to a demand by the user from the service candidate group using the service information and selection information acquired based on an instruction by the user;
present the user with the item of the work condition set in association with the target service in a format in which information is selectable or inputable by the user with respect to each item of the work condition;
acquire the information which is selected or input by the user with respect to the item of the work condition set in association with the target service as request information for specifying a request by the user; and
determine the provision requirement based on the acquired request information.

15. The transaction assistance system according to claim 12, further comprising a communication apparatus configured to receive data indicating the information item corresponding to the service from a terminal of the supplier;
wherein the processor sets the item of the work condition based on the received data.

16. The transaction assistance system according to claim 7, wherein the processor sets, as the item of the work condition, at least one of a method of manufacturing or a method of processing the article, a material of the article, a presence or absence of aftertreatment, a presence or absence of post-processing, and an apparatus used to manufacture or process the article.

17. The transaction assistance system according to claim 6, wherein
the processor sets an item of model data for specifying the article as the information item necessary for the supplier with respect to the article-related service,
the processor presents the user with the item of the model data set in association with the target service in the format in which the model data is uploadable by the user, and
the processor acquires the model data, which is uploaded by the user with respect to the item of the model data set in association with the target service, as the request information.

18. The transaction assistance system according to claim 17, wherein the processor presents the user with an article image expressing the article based on the model data together with the item of the work condition.

19. The transaction assistance system according to claim 18, wherein
the processor acquires annotation data for displaying an annotation image obtained by writing annotation information which indicates a request by the user related to at least a part of the item of the work condition to the presented article image, and
the processor presents the supplier with the annotation image based on the acquired annotation data.
